(19) United States
(12) Patent Application Publication
(10) Pub. No.: US 2026/0277807 A1
(43) Pub. Date: Sep. 17, 2026

(54) MEMORY SYSTEM AND OPERATING METHOD OF MEMORY SYSTEM

(71) Applicant: SK hynix Inc., Gyeonggi-do (KR)

(72) Inventor: Dong Hun JEONG, Gyeonggi-do (KR)

(21) Appl. No.: 19/417,330

(22) Filed: Dec. 12, 2025

(30) Foreign Application Priority Data
Mar. 12, 2025 (KR) 10-2025-0032152
Jul. 2, 2025 (KR) 10-2025-0088637

(51) Int. Cl. G06F 12/0802

(52) U.S. Cl. CPC G06F 12/0802; G06F 2212/60

(57) ABSTRACT

A memory system includes a cache memory storing a data symbol and a parity symbol, and a main memory storing the data symbol. A controller generates a first virtual tag symbol including tag information used to identify a location where the data symbol is stored in the main memory, and generates a second virtual tag symbol including tag information indicating where a cache hit of the data symbol is expected in the cache memory, based on an access address received from a host. An ECC engine performs encoding on the data symbol and a first virtual tag symbol, generates the parity symbol based on the encoding, performs decoding on the second virtual tag symbol, and the data symbol and the parity symbol read from the cache memory, and checks an error in the data symbol and an error in the second virtual tag symbol based on the decoding.

### CROSS-REFERENCE TO RELATED APPLICATIONS

The present application claims priority under 35 U.S.C. § 119(a) to Korean patent application No. 10-2025-0032152 filed on March 12, 2025, and Korean patent application No. 10-2025-0088637 filed on July 2, 2025, the entire disclosures of which are incorporated herein by reference.

### BACKGROUND

### Technical Field

Embodiments of the present disclosure generally relate to an electronic device, and more particularly, to a memory system and a method of operating the memory system.

### Related Art

A memory system stores data under the control of a host device, such as a computer or a smartphone. The memory system may include a memory device where data is stored and a memory controller that controls the memory device. Memory devices are categorized into volatile memory devices and non-volatile memory devices.

Memory systems need to simultaneously satisfy reliability and performance requirements in environments demanding high-speed computation and large-capacity storage. To this end, a memory system may include a controller, a cache memory, and a main memory. The cache memory based on Dynamic Random Access Memory (DRAM) can reduce data access latency between the system and the main memory. Data stored in the cache memory may be corrupted due to soft errors or electrical noise. To detect and recover from the errors in the cached data, an Error Correction Code (ECC) engine may be incorporated within the controller or a memory module.

### SUMMARY

Embodiments provide a memory system and an operating method thereof that can reduce the overhead of tag information stored in a cache memory.

A memory system according to an embodiment of the present disclosure may include a cache memory configured to store a data symbol and a parity symbol, a main memory configured to store the data symbol, a controller configured to generate a first virtual tag symbol including tag information used to identify a location where the data symbol is stored in the main memory, and generate a second virtual tag symbol including tag information indicating where a cache hit of the data symbol is expected in the cache memory, based on an access address received from a host, and an error correction code (ECC) engine configured to perform encoding on the data symbol and a first virtual tag symbol, generate the parity symbol based on a result of the encoding, perform decoding on the second virtual tag symbol, and the data symbol and the parity symbol read from the cache memory, and check an error in the data symbol and an error in the second virtual tag symbol based on a result of the decoding.

A method of operating a memory system according to an embodiment of the present disclosure may include generating a first virtual tag symbol including tag information used to identify a location where a data symbol is stored in a main memory, reading, from a cache memory, the data symbol and a parity symbol based on an access address received from a host, generating a second virtual tag symbol including tag information for which a cache hit of the data symbol in the cache memory is expected, based on the access address, performing decoding on the second virtual tag symbol, and the data symbol and the parity symbol read from the cache memory, and checking an error in the data symbol and an error in the second virtual tag symbol based on a result of the decoding.

### BRIEF DESCRIPTION OF THE DRAWINGS

The above and other aspects and features of embodiments according to the present disclosure may become more apparent by describing, in further detail, aspects of some embodiments thereof with reference to the accompanying drawings, in which:

FIG. 1 is a diagram illustrating the configuration and operation of a memory system according to an embodiment of the present disclosure;

FIG. 2 is a diagram illustrating cache hits and cache misses according to an embodiment of the present disclosure;

FIG. 3 is a diagram illustrating the structure of a cache memory of FIG. 1 according to an embodiment of the present disclosure;

FIGS. 4A and 4B are diagrams illustrating ECC encoding and ECC decoding according to an embodiment of the present disclosure;

FIG. 5 is a diagram illustrating the structure of a cache memory of FIG. 1 according to an embodiment of the present disclosure;

FIGS. 6A and 6B are diagrams illustrating ECC encoding and ECC decoding according to an embodiment of the present disclosure;

FIG. 7 is a flowchart illustrating the operation of a memory system according to an embodiment;

FIG. 8 is a flowchart illustrating the operation of a memory system according to an embodiment; and

FIG. 9 is a flowchart illustrating the operation of a memory system according to an embodiment.

### DETAILED DESCRIPTION

Specific structural or functional descriptions of examples of embodiments in accordance with concepts which are disclosed in this specification are illustrated only to describe the examples of embodiments in accordance with the concepts and the examples of embodiments in accordance with the concepts may be carried out by various forms but the descriptions are not limited to the examples of embodiments described in this specification.

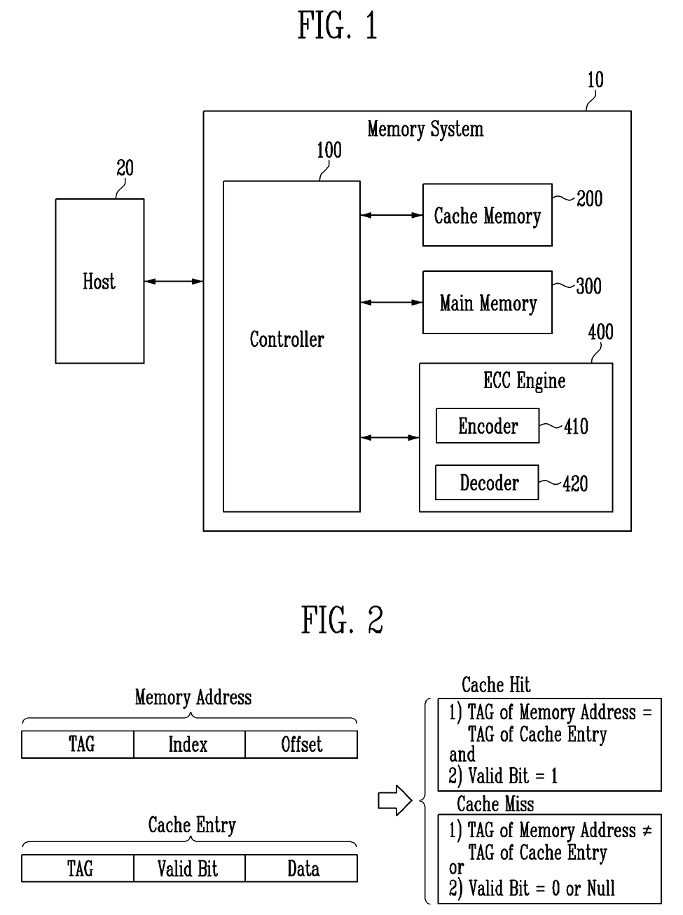

FIG. 1 is a diagram illustrating the configuration and operation of a memory system 10 according to an embodiment of the present disclosure.

Referring to FIG. 1, the memory system 10 may include a controller 100, a cache memory 200, a main memory 300, and an Error Correction Code (ECC) engine 400.

The memory system 10 stores data under the control of a host 20, such as a mobile phone, a smartphone, an MP3 player, a laptop computer, a desktop computer, a game console, a TV, a tablet PC, or an in-vehicle infotainment system.

The memory system 10 may be manufactured as one of various types of memory systems depending on a communication method with the host 20. For example, the memory system 10 may be manufactured as one of various types of memory systems such as a multimedia card in the form of a Solid State Drive (SSD), a Multi-Media Card (MMC), an embedded MMC (eMMC), Reduced-Size MMC (RS-MMC), or micro-MMC, a secure digital card in the form of an SD, mini-SD, or micro-SD, a universal serial bus (USB) memory system, a universal flash storage (UFS) device, a memory system in the form of a peripheral component interconnection (PCI) card, a memory system in the form of a PCI express (PCI-e or PCIe) card, a compact flash (CF) card, a smart media card, and a memory stick.

The memory system 10 may be manufactured in one of various package forms. For example, the memory system 10 may be manufactured in one of various package forms such as Package on Package (POP), System in Package (SIP), System on Chip (SOC), Multi-Chip Package (MCP), Chip on Board (COB), Wafer-Level Fabricated Package (WFP), and Wafer-Level Stack Package (WSP).

The cache memory 200 is positioned between the controller 100 and the main memory 300 and serves to store frequently referenced data while reducing data access latency. The cache memory 200 is typically organized into ‘cache lines’, with each line storing data and ‘tag’ information identifying the corresponding memory block. When an access request for a specific address is received, the controller 100 compares cache lines using a tag for the corresponding address and determines whether it is a cache hit or a cache miss based on the match. A cache miss occurs when the requested data is not found in the cache memory 200. A cache hit occurs when a valid copy of the requested data is found in the cache memory 200. When a cache miss occurs, the controller 100 reads the data from the main memory 300, updates the corresponding cache line, and stores new tag information. The new tag information may be generated based on the upper bits of the access address received from the host 20.

The DRAM-based cache memory 200 operates as a faster temporary storage space than the main memory 300, utilizing large capacity and high-speed characteristics, and may also provide ECC protection.

The main memory 300 may store data. The main memory 300 operates in response to control from the controller 100. The main memory 300 may include a plurality of memory blocks. A memory block may include a plurality of memory cells for storing data.

According to an embodiment, the cache memory 200 and the main memory 300 may be one or more of Random Access Memory (RAM), Non-Volatile Memory (NVM), Double Data Rate Synchronous Dynamic Random Access Memory (DDR SDRAM), Low Power Double Data Rate4 Synchronous Dynamic Random Access Memory (LPDDR4 SDRAM), Graphics Double Data Rate Synchronous Dynamic Random Access Memory (GDDR SDRAM), Low Power Double Data Rate (LPDDR), Rambus Dynamic Random Access Memory (RDRAM), NAND flash memory, Resistive Random Access Memory (RRAM), Phase-Change Random Access Memory (PRAM), Magnetoresistive Random Access Memory (MRAM), Ferroelectric Random Access Memory (FRAM), and Spin Transfer Torque Random Access Memory (STT-RAM).

The main memory 300 may be configured to receive a command and an address from the controller 100 and to access an area selected by the address within a storage area. That is, the main memory 300 may perform an operation specified by the command for the area selected by the address. For example, the main memory 300 may perform write operations (program operations), read operations, and erase operations. During a program operation, the main memory 300 may program data into the area selected by the address. During a read operation, the main memory 300 may read data stored in the area selected by the address. During an erase operation, the main memory 300 may erase data stored in the area selected by the address.

The controller 100 controls the overall operation of the memory system 10.

According to an embodiment, the controller 100 may receive data and an access-requested logical address from the host 20 and convert (translate) the logical address into a physical address indicating the addresses of memory cells where the data included in the main memory 300 is stored.

The controller 100 may control the main memory 300 to perform program operations, read operations, or erase operations according to the request from the host 20. During a program operation, the controller 100 may provide a write command, a physical address, and data to the main memory 300. During a read operation, the controller 100 may provide a read command and a physical address to the main memory 300. During an erase operation, the controller 100 may provide an erase command and a physical address to the main memory 300.

The ECC engine 400 is a dedicated circuit block responsible for error detection and correction of data and may include an encoder 410 and a decoder 420. The encoder 410 may operate before data is stored in the cache memory 200 or the main memory 300, and the decoder 420 may operate when data is read from the cache memory 200 or the main memory 300. According to an embodiment, the ECC engine 400 may utilize an ECC technique based on Reed-Solomon (RS) codes.

The encoder 410 may generate a parity bit by applying a predetermined error correction code algorithm to original data transferred from the host 20 or the controller 100. The encoder 410 may generate a codeword by adding the parity bit to the original data. Data stored in the cache memory 200 or the main memory 300 in the form of the codeword, along with the generated parity bit, may be verified in the same manner as the data is read later.

The decoder 420 may receive the codeword read from the cache memory 200 or the main memory 300 as input and may perform a decoding process which analyzes both the stored parity bit and the data bit.

The host 20 may communicate with the memory system 10 using at least one of a variety of communication methods, such as Compute Express Link (CXL), Universal Serial Bus (USB), Serial AT Attachment (SATA), Serial Attached SCSI (SAS), High Speed Interchip (HSIC), Small Computer System Interface (SCSI), Peripheral Component Interconnection (PCI), PCI express (PCIe), NonVolatile Memory express (NVMe), Universal Flash Storage (UFS), Secure Digital (SD), MultiMedia Card (MMC), embedded MMC (eMMC), Dual In-line Memory Module (DIMM), Registered DIMM (RDIMM), Load Reduced DIMM (LRDIMM), and the like.

According to an embodiment, the cache memory 200 may store a data symbol and a parity symbol. The main memory 300 may store the data symbol. The cache memory 200 may include a Random Access Memory (RAM), and the main memory 300 may include a Non-Volatile Memory.

According to an embodiment, the controller 100 may generate a first virtual tag symbol used when the ECC engine 400 performs encoding and a second virtual tag symbol used when the ECC engine 400 performs decoding. The first virtual tag symbol may include tag information used to identify a location where the data symbol is stored in the main memory 300. The second virtual tag symbol may include tag information indicating where a cache hit of the data symbol is expected within the cache memory 200. The second virtual tag symbol may be generated based on an access address requested from the host 20 to the controller 100.

The controller 100 may read the data symbol and the parity symbol from the cache memory 200 based on the access address prior to decoding. The controller 100 may discard the first virtual tag symbol without storing the first virtual tag symbol in the cache memory 200 after encoding.

The controller 100 may determine a cache hit when no error is detected in the data symbol and no error is detected in the second virtual tag symbol from the decoding result and may provide the data symbol to the host 20. The controller 100 may determine that a cache hit occurs when, as the result of decoding, the error is detected in the data symbol, but no error is detected in the second virtual tag symbol, and may provide, to the host 20, the data symbol corrected by the ECC engine 400.

The controller 100 may determine that a cache miss has occurred when the error is detected in the second virtual tag symbol as the result of decoding. When the controller 100 determines a cache miss, the controller 100 may read the data symbol stored in the main memory 300 based on the access address and may provide, to the host 20, the data symbol read from the main memory 300. The controller 100 may update the cache memory 200 based on the read data symbol from the main memory 300.

The ECC engine 400 may perform encoding on the data symbol and the first virtual tag symbol. The ECC engine 400 may generate a parity symbol based on the result of the encoding. The ECC engine 400 may perform decoding on the second virtual tag symbol, and the data symbol and the parity symbol read from the cache memory 200. The ECC engine 400 may check for an error in the data symbol and an error in the second virtual tag symbol based on the result of the decoding. The ECC engine 400 may perform encoding and decoding using Reed-Solomon codes.

The ECC engine 400 may re-perform decoding for all possible values which the second virtual tag symbol may have when the error in the data symbol or the error in the second virtual tag symbol is detected from the decoding result.

The encoder 410 may perform encoding based on the data symbol and the first virtual tag symbol and may generate a parity symbol based on the result of the encoding. The decoder 420 may perform decoding based on the second virtual tag symbol, and the data symbol and the parity symbol read from the cache memory 200 and may correct the error in the data symbol and the error in the second virtual tag symbol based on the result of the decoding.

FIG. 2 is a diagram illustrating cache hits and cache misses according to an embodiment of the present disclosure.

Referring to FIG. 2, a memory address may include a tag, an index, and an offset. The memory address may be an address of data requested for access by the host 20. The index is used to select a predetermined cache line within the cache memory 200, and a bit count may be determined based on the number of lines in the cache memory 200. The offset specifies the location of the data to be accessed within the selected cache line, and the size may be determined by a byte size of the cache line. The offset is a portion of a memory address that determines a specific byte within a cache line, while the size of the offset is determined by the block size (or cache line size) of the cache.

A cache entry is information stored in a cache line and may include a tag, a valid bit, and data. When the valid bit is set to one (1), the data is valid; when the valid bit is set to zero (0), the data may be invalid. When the valid bit is set to Null, there may be no data stored in the cache line.

The process for determining a cache hit and a cache miss is as follows:

The cache line corresponding to the index extracted from the memory address is located, the valid bit is checked, and then the tag of the memory address is compared with the tag of the cache entry stored in the cache line. When the valid bit is one (1) and two tags match, it is determined to be a cache hit. The exact data location within the cache line is referenced via the offset, and the data from the selected cache entry may be returned.

When the value of the valid bit is zero (0) or Null, or when tags differ, it may be determined as a cache miss. Data is fetched from the main memory 300, the cache entry stored in the cache line is updated, and a new tag and a valid bit may be stored. Through this process, the cache memory 200 may increase the reusability of the recently accessed data.

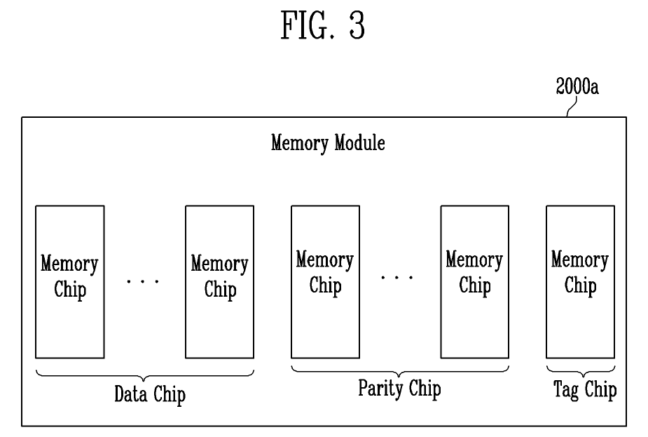

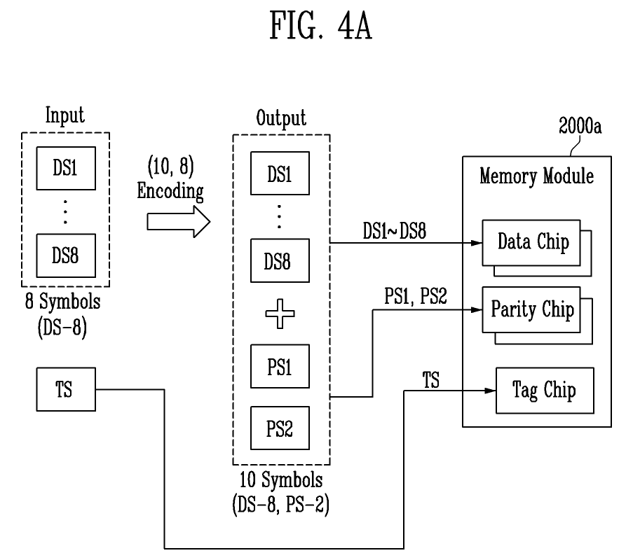

FIG. 3 is a diagram illustrating the structure of the cache memory 200 of FIG. 1 according to an embodiment of the present disclosure.

Referring to FIG. 3, a memory module 2000a may represent an example of the structure of the cache memory 200 as described with reference to FIG. 1.

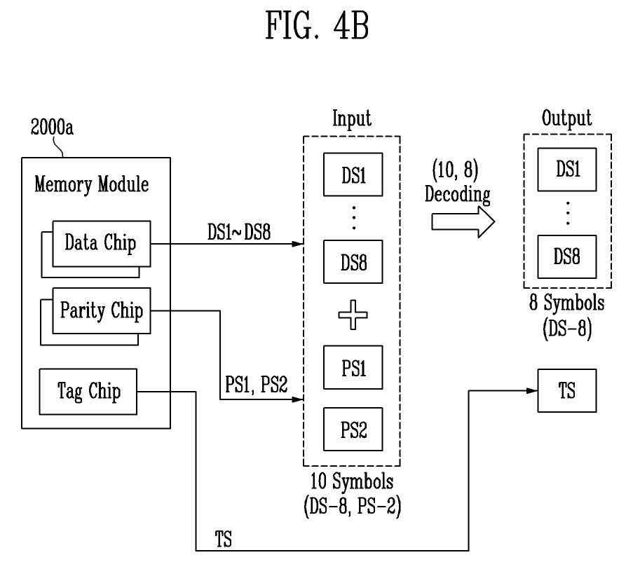

The memory module 2000a may include a plurality of memory chips. Among the plurality of memory chips, a data chip may be a memory chip storing a data symbol as described with reference to FIGS. 4A and 4B. Among the plurality of memory chips, a parity chip may be a memory chip storing a parity symbol as described with reference to FIGS. 4A and 4B. Among the plurality of memory chips, a tag chip may be a memory chip which stores a tag symbol as described with reference to FIGS. 4A and 4B.

FIGS. 4A and 4B are diagrams illustrating ECC encoding and ECC decoding according to an embodiment of the present disclosure.

According to an embodiment, ECC encoding and ECC decoding may be performed based on a Reed-Solomon (RS) code. The RS code may be a symbol-based block code widely used to correct multi-bit errors. In the RS code, data bits grouped into a symbol unit of a fixed size (e.g., eight bits) may be handled and errors occurring across a plurality of symbols may be detected and corrected at the symbol level. For example, an RS code adds 2t additional symbols (parity symbols) to correct up to t symbol errors within a single codeword. These parity symbols may be generated using polynomial operations over a Galois field (GF). The memory system utilizes the symbol-level error correction capability of RS codes to primarily guard against multi-bit errors such as burst errors or chip-level failures.

In particular, server memory protection technology known as Chipkill enables data recovery even during a single chip failure by configuring an ECC such that bits provided by a single DRAM chip may be treated as a single RS symbol. In summary, RS codes may be a powerful ECC method which effectively detects and corrects even chip-level multi-bit errors which may occur in the memory system by adding polynomial-based parity to symbolized data blocks.

The ECC encoding and the ECC decoding performed as shown in FIGS. 4A and 4B may be based on a (10,8) RS code. The (10,8) RS code consists of eight data symbols DS1 to DS8 and two parity symbols PS1 and PS2, enabling correction of one symbol error. The number of data symbols input to the RS code and the number of parity symbols output are not limited to this embodiment.

The process described in FIG. 4A may be performed when the data is stored in the cache memory.

For example, in FIG. 4A, eight data symbols DS1 to DS8 (e.g., (DS-8), 8 symbols) may be input, and ECC encoding based on the (10,8) RS code may be performed. As a result of encoding, the eight data symbols DS1 to DS8 and two parity symbols PS1 and P2 may be output (i.e., (DS-8, PS-2), 10 symbols). A tag symbol TS may include tag information within the cache memory corresponding to the eight data symbols DS1 to DS8. The eight data symbols DS1 to DS8 may be stored in a data chip within the memory module 2000a, the two parity symbols PS1 and P2 may be stored in a parity chip, and the one tag symbol TS may be stored in a tag chip.

The process as described in FIG. 4B may be performed when the data is read from the cache memory.

For example, the eight data symbols DS1 to DS8 stored in the data chip, the two parity symbols PS1 and P2 stored in the parity chip, and the one tag symbol TS stored in the tag chip may be read.

The read eight data symbols DS1 to DS8 and two parity symbols PS1 and P2 are input, and ECC decoding based on the (10,8) RS code may be performed. As a result of the decoding, it may be checked whether any of the eight data symbols DS1 to DS8 have errors. When an error occurs in one of the eight data symbols DS1 to DS8, the error may be corrected. The read tag symbol TS may be used to determine a cache hit or a cache miss based on the access address requested by the host.

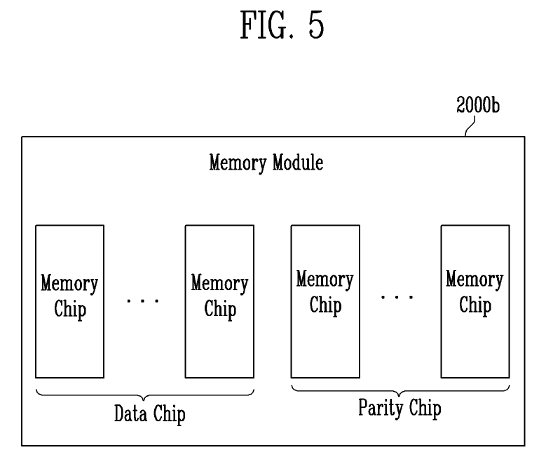

FIG. 5 is a diagram illustrating the structure of the cache memory 200 of FIG. 1 according to an embodiment of the present disclosure.

Referring to FIG. 5, a memory module 2000b may represent an example of the structure of the cache memory 200 described with reference to FIG. 1.

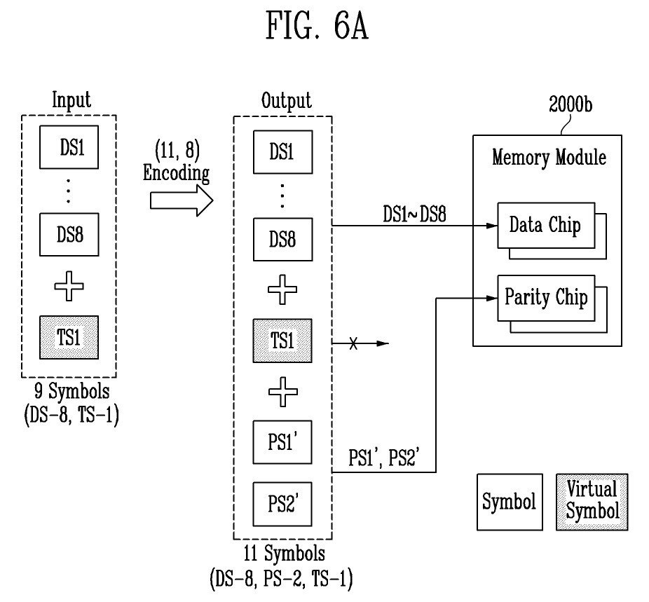

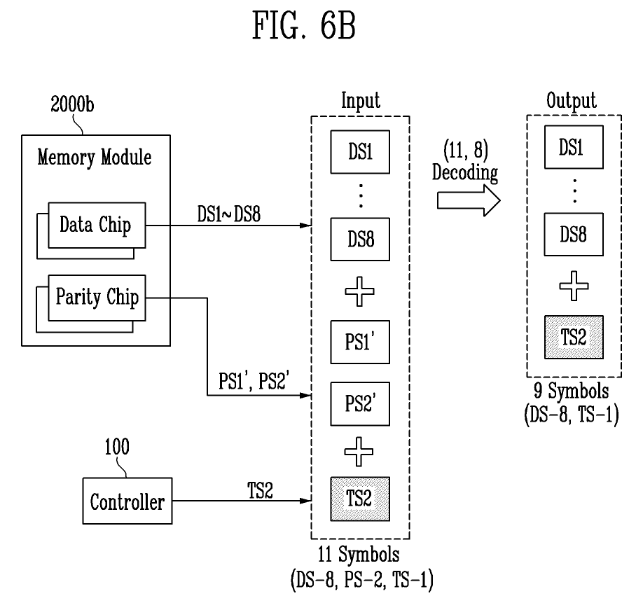

The memory module 2000b may include a plurality of memory chips. Among the plurality of memory chips, a data chip may be a memory chip storing a data symbol as described with reference to FIGS. 6A and 6B. Among the plurality of memory chips, a parity chip may be a memory chip storing a parity symbol as described with reference to FIGS. 6A and 6B.

The memory module 2000b may not include a separate tag chip for storing tag symbols, compared to the memory module 2000a described with reference to FIG. 3.

FIGS. 6A and 6B are diagrams illustrating ECC encoding and ECC decoding according to an embodiment of the present disclosure.

According to an embodiment, virtual symbol-based error correction may be performed. The virtual symbol-based error correction may be a concept of enhancing data integrity by using a logical symbol which is included in an ECC codeword but is not physically stored. More specifically, in a memory system, additional information such as an address tag of a cache or memory block may be treated as one symbol of an ECC, allowing that information to be protected by the ECC without requiring additional storage space.

During ECC decoding, iterative decoding may be performed for all possible values of the virtual tag symbol to determine the most reliable data combination. This structure may expand correction coverage without increasing the number of physical parity bits, and may effectively prevent an abnormal operation caused by errors or tag mismatches occurring during cache access.

For example, when an ECC for a single data block (a cache line) is calculated, a portion (a tag) of an address of the corresponding block may be used as additional input, such as in the form of a hash, to generate a parity check bit. In this manner, the ECC parity reflects not only the data content but also the address information associated with the data, forming an integrity code for the data-address combination. When the data block is read from the memory, the memory controller may again compute the tag hash from the current access address using the same method and may perform ECC verification along with the read data.

When an error exists in a data bit, the ECC decoder may detect and correct the error or issue an error signal. Conversely, even when the data is intact but an error occurs in the address tag, causing data from the wrong address to be returned, the ECC verification may detect a mismatch with the originally calculated parity and recognize the mismatch as an error.

Thus, utilizing tag-based virtual symbols enables the capture of address line errors or incorrect data responses which are difficult to detect with the conventional ECC in the memory or cache system.

The (10,8) RS code as described with reference to FIGS. 4A and 4B consists of eight data symbols and two parity symbols, enabling correction of one symbol error.

In an (11,8) RS code as described with reference to FIGS. 6A and 6B, tag information related to a memory address may be defined as a ‘virtual tag symbol’ and be added to the existing RS encoding process (i.e., (DS-8, PS-2, TS-1), 11 symbols). For example, by performing (11,8) RS encoding which generates two parity symbols from eight data symbols and one virtual tag symbol as input, richer context information may be included within the ECC protection scope while the same correction capability as before is maintained. Furthermore, since no separate space is required within the memory module 2000b to store tag information, manufacturing and storage costs may be reduced.

The process as described in FIG. 6A may be performed when the data is stored in the cache memory.

For example, in FIG. 6A, the eight data symbols DS1 to DS8 and a first virtual tag symbol TS1 may be input, and ECC encoding based on the (11,8) RS code may be performed. The first virtual tag symbol TS1 may include tag information within the cache memory corresponding to the eight data symbols DS1 to DS8.

As a result of encoding, the eight data symbols DS1 to DS8 and two parity symbols PS1’ and P2’ may be output. The eight data symbols DS1 to DS8 are stored in the data chip within the memory module 2000a, and the two parity symbols PS1’ and P2’ may be stored in the parity chip within the memory module 2000a. However, the first virtual tag symbol TS1 may be discarded and not stored in the memory module 2000b.

The process as described in FIG. 6B may be performed when the data is read from the cache memory.

For example, in FIG. 6B, the eight data symbols DS1 to DS8 stored in the data chip and the two parity symbols PS1’ and PS2’ stored in the parity chip may be read. The controller 100 may generate a second virtual tag symbol TS2 including tag information for which a cache hit of the eight data symbols DS1 to DS8 in the cache memory is expected, based on the access address requested from the host.

The eight data symbols DS1 to DS8 read from the memory module 2000b, the two parity symbols PS1’ and PS2’, and the second virtual tag symbol TS2 received from the controller 100 are input, and ECC decoding based on the (11,8) RS code may be performed. The result of the decoding may enable the controller 100 to check whether errors have occurred in the eight data symbols DS1 to DS8 and the second virtual tag symbol TS2.

When no errors occur in the eight data symbols DS1 to DS8 and the second virtual tag symbol TS2, the first virtual tag symbol TS1 and the second virtual tag symbol TS2 match, so a cache hit may be determined. The read eight data symbols DS1 to DS8 may be provided directly to the host.

Even when an error occurs in one of the eight data symbols DS1 to DS8, the error may be corrected. When no error occurs in the second virtual tag symbol TS2, the first virtual tag symbol TS1 and the second virtual tag symbol TS2 match, so a cache hit may be determined. The error-corrected one data symbol and the remaining seven data symbols read correctly may be provided to the host.

When an error has occurred in one of the eight data symbols DS1 to DS8 and the second virtual tag symbol TS2, the first virtual tag symbol TS1 and the second virtual tag symbol TS2 do not match, so a cache miss may be determined. The eight data symbols DS1 to DS8 read from the main memory may be provided to the host.

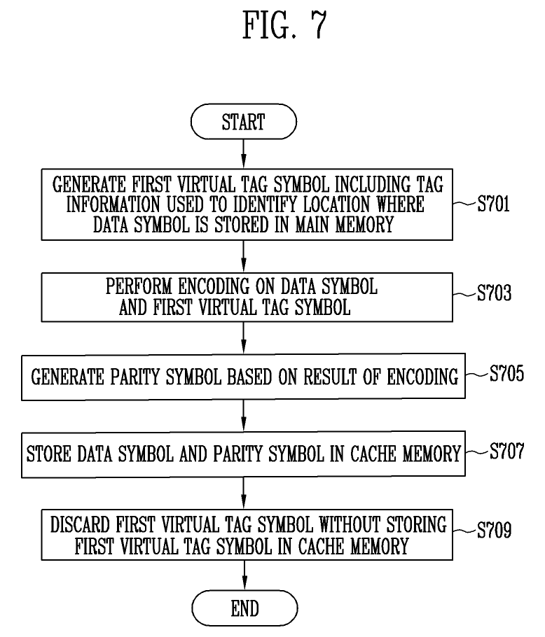

FIG. 7 is a flowchart illustrating the operation of the memory system according to an embodiment.

Referring to FIG. 7, in S701, the memory system may generate a first virtual tag symbol including tag information used to identify a location where a data symbol is stored in the main memory.

In S703, the memory system may perform encoding on the data symbol and the first virtual tag symbol.

In S705, the memory system may generate a parity symbol based on a result of the encoding.

In S707, the memory system may store the data symbol and the parity symbol in the cache memory.

In S709, the memory system may discard the first virtual tag symbol without storing the first virtual tag symbol in the cache memory.

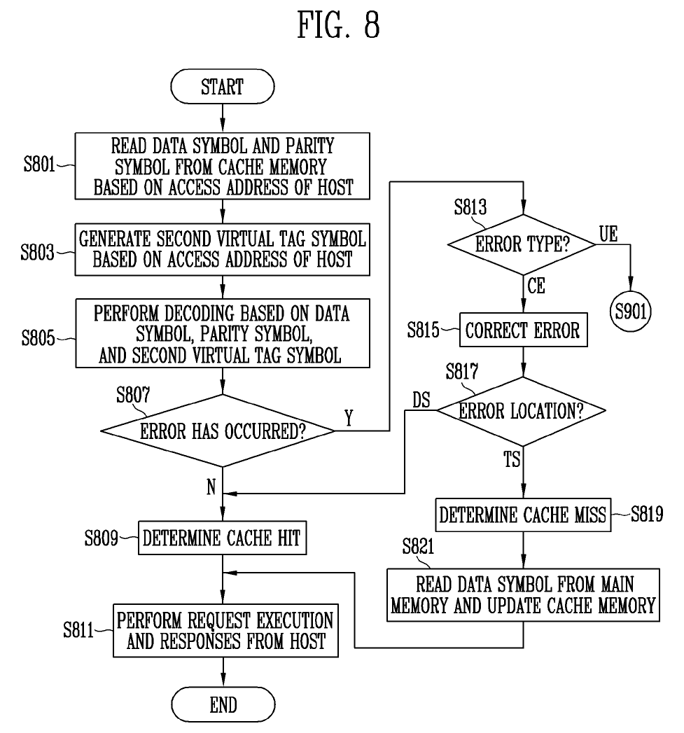

FIG. 8 is a flowchart illustrating the operation of the memory system according to an embodiment.

Referring to FIG. 8, in S801, the memory system may read a data symbol and a parity symbol from the cache memory based on an access address of the host.

In S803, the memory system may generate a second virtual tag symbol based on the access address of the host. The second virtual tag symbol may include tag information indicating where a cache hit for the data symbol within the cache memory is expected.

In S805, the memory system may perform decoding on the data symbol, the parity symbol, and a second virtual tag symbol.

In S807, the memory system may determine whether an error has occurred in the data symbol and the second virtual tag symbol based on a result of the decoding. When the error has occurred (S807, Y), the process flow proceeds to S813; when no error occurs (S807, N), the process flow proceeds to S809.

In S809, the memory system may determine a cache hit. The cache hit may mean that the data symbol corresponding to the access address requested by the host exists within the cache memory.

In S811, the memory system may provide the host with the data symbol read from the cache memory in S801, an error-corrected data symbol in S815, or a data symbol read from the main memory in S821 in response to request execution and (receiving) responses from the host.

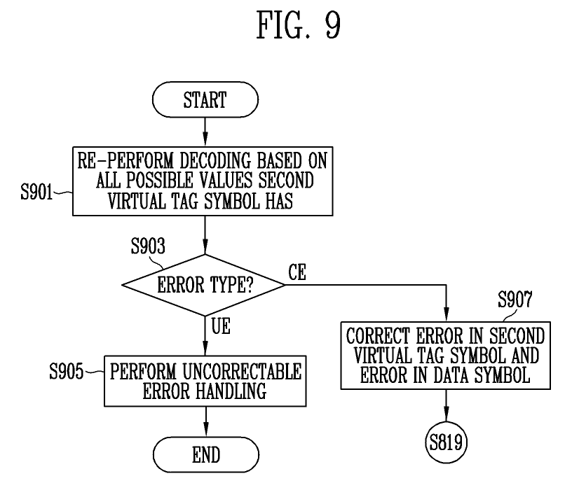

In S813, the memory system may determine whether a type of error which has occurred is a correctable error (CE) or an uncorrectable error (UE). When the error type is a correctable error (S813, CE), the process flow proceeds to S815; when the error type is an uncorrectable error (S813, UE), the process flow proceeds to S901 of FIG. 9. An uncorrectable error may indicate an error exceeding the error correction capability of the memory system.

In S815, the memory system may correct an error in the data symbol or an error in the second virtual tag symbol.

In S817, the memory system may determine the location of the error which has occurred in S807. When the determination indicates that the error has occurred in the data symbol (DS) (S817, DS), the process flow proceeds to S809. When the error has occurred in the second virtual tag symbol (TS) (S817, TS), the process flow proceeds to S819.

In S819, the memory system may determine a cache miss. The cache miss may mean that the data symbol corresponding to the access address requested by the host does not exist within the cache memory.

In S821, the memory system may read a data symbol from the main memory based on the access address and may update the cache memory based on the read data symbol.

FIG. 9 is a flowchart illustrating the operation of the memory system according to one embodiment.

Referring to FIG. 9, in S901, the memory system may repeat and re-perform decoding by considering all possible values which the second virtual tag symbol may have.

In S903, the memory system may determine whether an error type is a correctable error (CE) or an uncorrectable error (UE) based on a result of the decoding.

For example, when the error correction capability of the memory system may only correct an error for a single symbol, in S813 of FIG. 8, an error occurring simultaneously in both a data symbol and a second virtual tag symbol may be determined as an uncorrectable error. Subsequently, in S901, decoding is re-performed for all possible values of the second virtual tag symbol. As a result, the error in the second virtual tag symbol may be corrected. Since it may be viewed as only one data symbol having an error, the error may be determined as a correctable error.

As another example, in S813, when an error occurs in two data symbols, the error may be determined as an uncorrectable error. Since the decoding performed in S901 may not be able to correct the error in the two data symbols, the error may be determined as an uncorrectable error.

When the error type is a correctable error, the process flow proceeds to S903; when the error type is an uncorrectable error (S903, UE), the process flow proceeds to S905. The uncorrectable error may refer to an error exceeding the error correction capability of the memory system.

In S905, the memory system may perform uncorrectable error handling.

In S907, when the error type is a correctable error (S903, CE), the memory system may correct the error in the second virtual tag symbol and the error in the data symbol. The process flow may then proceed to S819.

According to the present disclosure, a memory system and an operating method thereof that can reduce the overhead of tag information stored in a cache memory are provided.

The embodiments disclosed in the present disclosure are not intended to limit the technical ideas of the present disclosure but rather to illustrate them. The scope of the technical ideas of the present disclosure is not limited by these embodiments. Rather, the scope of protection should be interpreted in accordance with the following claims, and all technical ideas within the scope equivalent thereto should be construed as falling within the scope of the present disclosure.

What is claimed is:

1. A memory system, comprising:
a cache memory configured to store a data symbol and a parity symbol;
a main memory configured to store the data symbol;
a controller configured to generate a first virtual tag symbol including tag information used to identify a location where the data symbol is stored in the main memory, and generate a second virtual tag symbol including tag information indicating where a cache hit of the data symbol is expected in the cache memory, based on an access address received from a host; and
an error correction code (ECC) engine configured to perform encoding on the data symbol and a first virtual tag symbol, generate the parity symbol based on a result of the encoding, perform decoding on the second virtual tag symbol, and the data symbol and the parity symbol read from the cache memory, and check an error in the data symbol and an error in the second virtual tag symbol based on a result of the decoding.

2. The memory system of claim 1, wherein the controller is configured to read, from the cache memory, the data symbol and the parity symbol based on the access address prior to the decoding of the ECC engine.

3. The memory system of claim 1, wherein the controller is configured to discard the first virtual tag symbol without storing the first virtual tag symbol in the cache memory after the encoding of the ECC engine.

4. The memory system of claim 1, wherein the controller is configured to determine a cache hit when no error is detected in the data symbol and no error is detected in the second virtual tag symbol from the result of the decoding of the ECC engine, and provide the data symbol to the host.

5. The memory system of claim 1, wherein the controller is configured to determine a cache hit when the error is detected in the data symbol and the error in the second virtual tag symbol is not detected from the result of the decoding of the ECC engine, control the ECC engine to correct the error in the data symbol, and provide, to the host, the data symbol corrected by the ECC engine.

6. The memory system of claim 1, wherein the controller is configured to, based on the result of the decoding of the ECC engine, determine a cache miss when the error is detected in the second virtual tag symbol, read, from the main memory, the data symbol based on the access address, and provide, to the host, the data symbol read from the main memory.

7. The memory system of claim 6, wherein the controller is configured to update the cache memory based on the data symbol read from the main memory.

8. The memory system of claim 1, wherein the ECC engine is configured to perform the encoding and the decoding using a Reed-Solomon code.

9. The memory system of claim 1, wherein the ECC engine is configured to, upon detecting the error in the data symbol or the error in the second virtual tag symbol from the result of the decoding, re-perform the decoding for all possible values of the second virtual tag symbol.

10. The memory system of claim 1, wherein the ECC engine comprises:
an encoder configured to perform the encoding based on the data symbol and the first virtual tag symbol, and generate the parity symbol based on the result of the encoding; and
a decoder configured to perform the decoding based on the second virtual tag symbol, and the data symbol and the parity symbol read from the cache memory, and correct the error in the data symbol and the error in the second virtual tag symbol based on the result of the decoding.

11. The memory system of claim 1, wherein the cache memory comprises a random access memory (RAM), and
the main memory comprises a non-volatile memory.

12. A method of operating a memory system, the method comprising:
generating a first virtual tag symbol including tag information used to identify a location where a data symbol is stored in a main memory;
reading, from a cache memory, the data symbol and a parity symbol based on an access address received from a host;
generating a second virtual tag symbol including tag information for which a cache hit of the data symbol in the cache memory is expected, based on the access address;
performing decoding on the second virtual tag symbol, and the data symbol and the parity symbol read from the cache memory; and
checking an error in the data symbol and an error in the second virtual tag symbol based on a result of the decoding.

13. The method of claim 12, further comprising:
performing encoding on the data symbol and the first virtual tag symbol;
generating the parity symbol based on a result of the encoding;
storing the data symbol and the parity symbol in the cache memory; and
discarding the first virtual tag symbol without storing the first virtual tag symbol in the cache memory.

14. The method of claim 12, wherein the checking the error further comprises:
determining a cache hit when no error is detected in the data symbol and no error is detected in the second virtual tag symbol; and
providing, to the host, the data symbol read from the cache memory.

15. The method of claim 12, wherein the checking the error further comprises:
determining a cache hit when the error in the data symbol is detected and no error in the second virtual tag symbol is detected;
correcting the error in the data symbol to generate a corrected data symbol; and
providing the corrected data symbol to the host.

16. The method of claim 12, wherein the checking the error further comprises:
determining a cache miss when the error is detected in the second virtual tag symbol;
reading, from the main memory, the data symbol based on the access address; and
providing, to the host, the data symbol read from the main memory.

17. The method of claim 16, further comprising updating the cache memory based on the data symbol read from the main memory.

18. The method of claim 12, wherein the checking the error further comprises re-performing the decoding for all possible values of the second virtual tag symbol, when the error in the data symbol and the error in the second virtual tag symbol are detected.

19. The method of claim 13, wherein the encoding and the decoding are performed using a Reed-Solomon code.

20. The method of claim 12, wherein the cache memory comprises a random access memory (RAM), and
the main memory comprises a non-volatile memory.
